(19) United States
(12) Patent Application Publication
(10) Pub. No.: US 2025/0311017 A1
(43) Pub. Date: Oct. 2, 2025

(54) IN-VEHICLE DEVICE, INFORMATION PROCESSING METHOD, AND INFORMATION PROCESSING PROGRAM

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP); TOYOTA JIDOSHA KABUSHIKI KAISHA, Toyota-Shi, Aichi (JP)

(72) Inventors: Yuichi KODAMA, Yokkaichi-Shi, Mie (JP); Makoto CHUJO, Osaka-Shi, Osaka (JP); Isao WATANABE, Toyota-Shi, Aichi (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP); TOYOTA JIDOSHA KABUSHIKI KAISHA, Toyota-Shi, Aichi (JP)

(21) Appl. No.: 18/863,149

(22) PCT Filed: May 1, 2023
(86) PCT No.: PCT/JP2023/017017

§ 371 Date: Nov. 5, 2024

(30) Foreign Application Priority Data
May 16, 2022 (JP) 2022-080373

(51) Int. Cl. H04W 76/10; H04W 4/48; H04W 84/20

(52) U.S. Cl. CPC H04W 76/10; H04W 4/48; H04W 84/20

(57) ABSTRACT

An in-vehicle device to be installed in a vehicle, the in-vehicle device includes: a communication unit configured to receive, from a management device, setting information related to a role of the in-vehicle device in an in-vehicle network; and a setting unit configured to perform operation setting for the in-vehicle device corresponding to the role based on the setting information received by the communication unit.

### CROSS-REFERENCE TO RELATED APPLICATIONS

This application is the U.S. national stage of PCT/JP2023/017017 filed on May 1, 2023, which claims priority of Japanese Patent Application No. JP 2022-080373 filed on May 16, 2022, the contents of which are incorporated herein.

### TECHNICAL FIELD

The present disclosure relates to an in-vehicle device, an information processing method, and an information processing program.

### BACKGROUND

Conventionally, technologies related to an in-vehicle network that includes a plurality of in-vehicle electronic control units (ECUs) have been developed.

A vehicle control device such as the following is disclosed in JP 2000-229546A (Patent Document 1). Specifically, the vehicle control device includes a central ECU 1 that performs overall management of operation of the vehicle, terminal ECUs 2a, 2b, to 2n that control operation of respective units of the vehicle, and an in-vehicle LAN 3 that connects these ECUs to each other; the central ECU obtains vehicle information indicating vehicle specifications from information on terminals that are selectively short-circuited by a vehicle information cartridge 8, which is constituted by a conductive component and mounted to a connector unit 7, provides the obtained information to the terminal ECUs, and sets the type of function to be realized in each of the terminal ECUs in accordance with the vehicle information. The vehicle specifications are managed by the vehicle information cartridge.

Conventionally, if an in-vehicle ECU is added or a function to be provided in vehicles is changed after vehicle shipment, settings have needed to be changed individually in each vehicle at the dealer or the like.

As described above, with the vehicle control device described in JP 2000-229546A, by using the vehicle information cartridge, functions and control characteristics that correspond to the vehicle specifications can be set in each in-vehicle ECU. However, in the case where an in-vehicle ECU is to be added or the settings of an in-vehicle ECU are to be changed, the vehicle information cartridge needs to be changed, or an additional vehicle information cartridge needs to be added, which poses a problem of not being able to make such accommodations in a flexible manner.

The present disclosure has been made to solve the above-mentioned problems, and an object of the present disclosure is to provide an in-vehicle device, an information processing method, and an information processing program that can easily adapt the in-vehicle device to the configuration of an in-vehicle network in a vehicle in which the in-vehicle device is installed.

### SUMMARY

An in-vehicle device according to the present disclosure is an in-vehicle device to be installed in a vehicle, including: a communication unit configured to receive, from a management device, setting information related to a role of the in-vehicle device in an in-vehicle network; and a setting unit configured to perform operation setting for the in-vehicle device corresponding to the role based on the setting information received by the communication unit.

An information processing method according to the present disclosure is an information processing method in an in-vehicle device to be installed in a vehicle, including the steps of receiving, from a management device, setting information related to a role of the in-vehicle device in an in-vehicle network; and performing operation setting for the in-vehicle device corresponding to the role based on the received setting information.

An information processing program according to the present disclosure is an information processing program for use in an in-vehicle device to be installed in a vehicle, the information processing program causing a computer to function as: a communication unit configured to receive, from a management device, setting information related to a role of the in-vehicle device in an in-vehicle network; and a setting unit configured to perform operation setting for the in-vehicle device corresponding to the role based on the setting information received by the communication unit.

One aspect of the present disclosure can be realized not only as an in-vehicle

device that includes such characteristic processing units, but also as a semiconductor integrated circuit that realizes a part or the entirety of the in-vehicle device, or a system that includes the in-vehicle device.

### Effects

With the present disclosure, it is possible to easily adapt the in-vehicle device to the configuration of the in-vehicle network in the vehicle in which the in-vehicle device is installed.

### BRIEF DESCRIPTION OF THE DRAWINGS

FIG. 1 is a diagram illustrating the configuration of a communication system according to an embodiment of the present disclosure.

FIG. 2 is a diagram illustrating the configuration of the management device according to the embodiment of the present disclosure.

FIG. 3 is a diagram illustrating an example of a setting information database stored in the storage unit in the management device according to the embodiment of the present disclosure.

FIG. 4 is a diagram illustrating an example of a setting information database stored in the storage unit in the management device according to the embodiment of the present disclosure.

FIG. 5 is a diagram illustrating an example of a screen displayed by the management device according to the embodiment of the present disclosure.

FIG. 6 is a diagram illustrating the relationship between the connection position and the role of the in-vehicle device according to the embodiment of the present disclosure in the in-vehicle network.

FIG. 7 is a diagram illustrating the relationship between the connection position and the role of the in-vehicle device according to the embodiment of the present disclosure in the in-vehicle network.

FIG. 8 is a diagram illustrating the configuration of the in-vehicle device according to the embodiment of the present disclosure and an example of a connection position of the in-vehicle device in the in-vehicle network.

FIG. 9 is a diagram illustrating an example of setting information stored in the storage unit in the in-vehicle device according to the embodiment of the present disclosure.

FIG. 10 is a diagram illustrating another example of a connection position of the in-vehicle device according to the embodiment of the present disclosure in the in-vehicle network.

FIG. 11 is a diagram illustrating an example of a software module information stored in the storage unit of the in-vehicle device according to the embodiment of the present disclosure.

FIG. 12 is a diagram illustrating an example of a communication form for each of the software modules in the in-vehicle device according to the embodiment of the present disclosure.

FIG. 13 is a diagram illustrating an example of a sequence in the communication system according to the embodiment of the present disclosure.

FIG. 14 is a diagram illustrating another example of the sequence in the communication system according to the embodiment of the present disclosure.

### DETAILED DESCRIPTION OF PREFERRED EMBODIMENTS

First, the details of an embodiment of the present disclosure are listed and described.

In a first aspect, an in-vehicle device according to an embodiment of the present disclosure is an in-vehicle device to be installed in a vehicle, including: a communication unit configured to receive, from a management device, setting information related to a role of the in-vehicle device in an in-vehicle network; and a setting unit configured to perform operation setting for the in-vehicle device corresponding to the role based on the setting information received by the communication unit.

With such a configuration, the role of an in-vehicle device that is added to a vehicle after the vehicle is shipped, or an in-vehicle device for which the functions to be provided in the vehicle are changed after the vehicle is shipped, can be easily set in accordance with the configuration of the in-vehicle network, which is different depending on the vehicle in which the in-vehicle device is installed. Therefore, it is possible to easily adapt the in-vehicle device to the configuration of the in-vehicle network in the vehicle in which the in-vehicle device is installed.

In a second aspect according to the first aspect, a configuration is possible in which, based on the setting information, the setting unit corresponds to the role in communication in the in-vehicle network.

With such a configuration, the role of the in-vehicle device can be easily set when the role of the in-vehicle device in communication in the in-vehicle network is different depending on the vehicle in which the in-vehicle device is installed.

In a third aspect according to the second aspect, a configuration is possible in which, based on the setting information, the setting unit switches whether the in-vehicle device is to perform communication as a commander or as a responder in the in-vehicle network.

With such a configuration, the in-vehicle device can easily adapt to a difference in the role of the in-vehicle device between communication standards such as LIN and Bluetooth (registered trademark) in the in-vehicle network.

In a fourth aspect, a configuration is possible in which, based on the setting information, the setting unit switches whether the in-vehicle device is to perform communication as an access point or as a station in the in-vehicle network.

With such a configuration, the in-vehicle device can easily adapt to a difference in the role of the in-vehicle device between communication standards such as WiFi (registered trademark) in the in-vehicle network.

In a fifth aspect according to any of the first through the fourth aspects, a configuration is possible in which, the communication unit receives the setting information for at least one of each vehicle model and each vehicle year.

With such a configuration, individual setting for accommodating a function to be realized does not need to be performed for each vehicle model or vehicle year, and operation setting can be easily performed for vehicles of different vehicle models or vehicle years.

In a sixth aspect according to any of the first through the fifth aspects, a configuration is possible in which, the setting unit uses the setting information in setting performed so that vehicle information regarding the vehicle is transmitted from the vehicle to the management device.

With such a configuration, vehicle information for executing a specific function can be collected from the vehicle that is the transmission destination of the setting information, and the function can be realized using the vehicle information.

In a seventh aspect, an information processing method according to an embodiment of the present disclosure is an information processing method in an in-vehicle device to be installed in a vehicle, including the steps of receiving, from a management device, setting information related to a role of the in-vehicle device in an in-vehicle network; and performing operation setting for the in-vehicle device corresponding to the role based on the received setting information.

With such a configuration, the role of an in-vehicle device that is added to a vehicle after the vehicle is shipped, or an in-vehicle device for which the functions to be provided in the vehicle are changed after the vehicle is shipped, can be easily set in accordance with the configuration of the in-vehicle network, which is different depending on the vehicle in which the in-vehicle device is installed. Therefore, it is possible to easily adapt the in-vehicle device to the configuration of the in-vehicle network in the vehicle in which the in-vehicle device is installed.

In an eighth aspect, an information processing program according to an embodiment of the present disclosure is an information processing program for use in an in-vehicle device to be installed in a vehicle, the information processing program causing a computer to function as: a communication unit configured to receive, from a management device, setting information related to a role of the in-vehicle device in an in-vehicle network; and a setting unit configured to perform operation setting for the in-vehicle device corresponding to the role based on the setting information received by the communication unit.

With such a configuration, the role of an in-vehicle device that is added to a vehicle after the vehicle is shipped, or an in-vehicle device for which the functions to be provided in the vehicle are changed after the vehicle is shipped, can be easily set in accordance with the configuration of the in-vehicle network, which is different depending on the vehicle in which the in-vehicle device is installed. Therefore, it is possible to easily adapt the in-vehicle device to the configuration of the in-vehicle network in the vehicle in which the in-vehicle device is installed.

Hereinafter, embodiments of the present disclosure will be described with reference to the drawings. Note that, in the drawings, the same reference numerals are given to the same or corresponding components in the drawings, and redundant descriptions thereof are not repeated. Furthermore, at least parts of the embodiments described below may be suitably combined.

### Overall Configuration

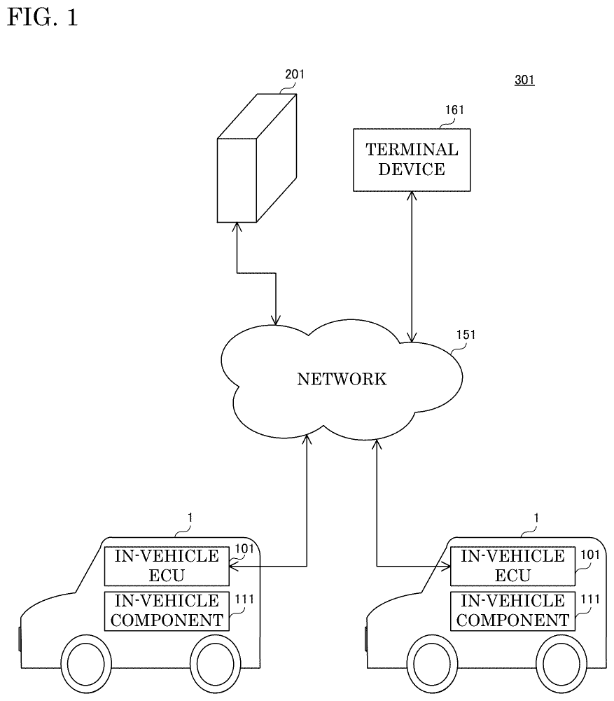

FIG. 1 is a diagram illustrating the configuration of a communication system according to an embodiment of the present disclosure. As shown in FIG. 1, a communication system 301 includes one or more in-vehicle ECUs 101, which are examples of in-vehicle devices, a terminal device 161, and a management device 201. The in-vehicle ECUs 101, the terminal device 161, and the management device 201 can transmit and receive information via a network 151 such as the Internet. The in-vehicle ECUs 101 are installed together with in-vehicle components 111 in vehicles 1.

The management device 201 is managed by, for example, a business operator that provides a function related to the vehicles 1. The terminal device 161 is managed by, for example, a business operator or an individual who carries out the function related to the vehicles 1 (hereinafter, collectively referred to as “the user”). Specifically, one example of a function related to the vehicles 1 is a function for managing the traveling history of the vehicles 1.

The management device 201 collects, from the one or more in-vehicle ECUs 101, vehicle information regarding the corresponding vehicle 1. The management device 201 also creates provision information used for executing the aforementioned function based on one or more pieces of the collected vehicle information. The vehicle information includes, for example, information regarding the traveling of the vehicles 1.

Specifically, the management device 201 collects, for example, position information and vehicle speed information regarding each of a plurality of vehicles 1, and based on the collected position information and vehicle speed information, creates provision information such as map information in which the traveling positions of the vehicles 1 are mapped on a map in a display mode corresponding to the vehicle speeds. A business operator (user) can use the provision information to manage the driving of the vehicles 1, for example.

Note that the vehicle information is not limited to position information or vehicle speed information, and may be, for example, brake information indicating a brake state. Also, the vehicle information is not limited to information regarding the traveling of the vehicle 1, and may also be information indicating measurement results obtained in the vehicle 1, specifically, information indicating a measurement result obtained by an in-vehicle component 111 such as a sensor in the vehicle 1, such as image information showing an image of the surroundings of the vehicle 1, the door open/closed status, and temperature information. The vehicle information may also be, for example, identification information of the vehicle 1 or network configuration information of the vehicle 1.

For example, the management device 201 creates, for each vehicle model or vehicle year, setting information indicating detailed network settings, i.e., the role that the in-vehicle ECU 101 should play in the in-vehicle network. For example, the setting information is used to set the communication operation of the in-vehicle ECU 101 corresponding to the role in communication in the in-vehicle network.

For example, the setting information is used to perform setting so that vehicle information regarding the vehicle 1 is transmitted from the vehicle 1 to the management device 201. In other words, the setting information is information related to setting to be performed in the vehicle 1 in order to acquire, from the vehicle 1, vehicle information used to create provision information.

### Configuration of Management Device

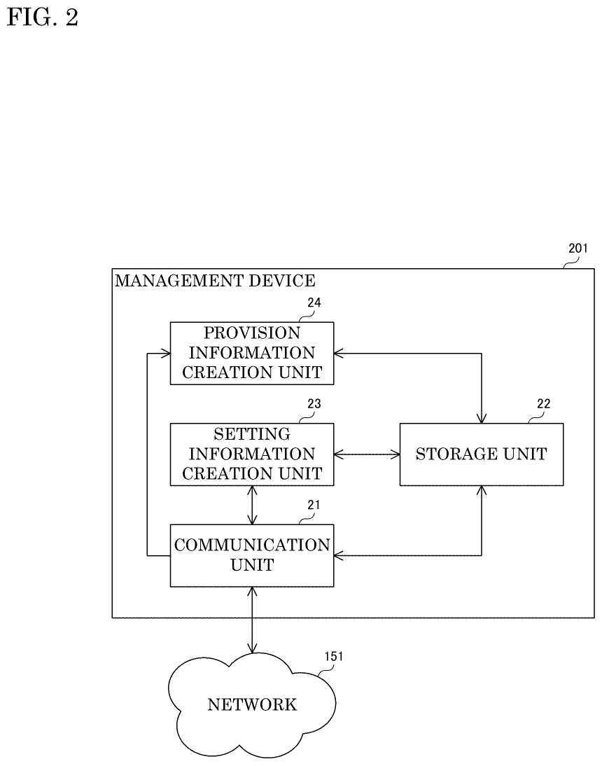

FIG. 2 is a diagram illustrating the configuration of the management device according to the embodiment of the present disclosure. As shown in FIG. 2, the management device 201 includes a communication unit 21, a storage unit 22, a setting information creation unit 23, and a provision information creation unit 24. Some or all of the communication unit 21, the setting information creation unit 23, and the provision information creation unit 24 are realized by a processor such as a central processing unit (CPU) or a digital signal processor (DSP). The storage unit 22 is, for example, a non-volatile memory.

The communication unit 21 transmits and receives information to and from the plurality of in-vehicle ECUs 101 and the terminal device 161 via the network 151.

The storage unit 22 stores a database of setting information related to the roles, i.e., behaviors of the in-vehicle ECUs 101 in the in-vehicle networks of the vehicles 1 for each vehicle model. The vehicle model is set, for example, according to the use and destination of the vehicle 1.

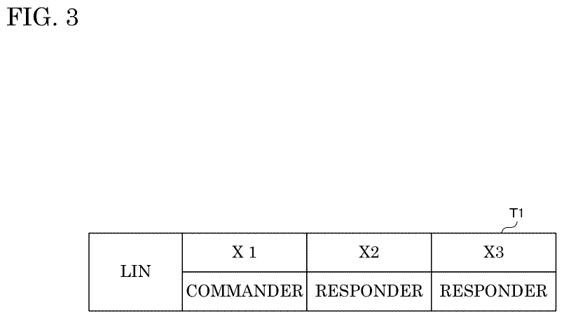

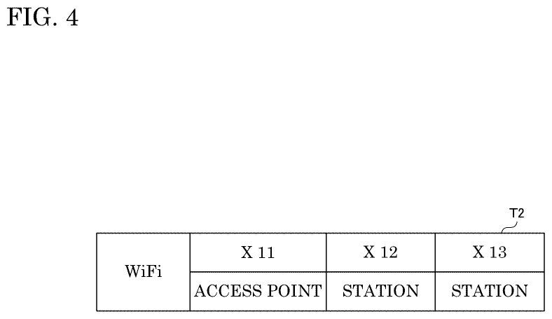

FIGS. 3 and 4 are diagrams illustrating an example of a setting information database stored in the storage unit in the management device according to the embodiment of the present disclosure.

As shown in FIGS. 3 and 4, the setting information indicates whether the in-vehicle ECU 101 communicates as a commander (master) or as a responder (slave) in the in-vehicle network. In addition, for example, the setting information indicates whether the in-vehicle ECU 101 performs communication as an access point or as a station in the in-vehicle network.

More specifically, the storage unit 22 stores, as a setting information database, a correspondence table T1 indicating the correspondence between vehicle models and the roles of the in-vehicle ECUs 101 in the in-vehicle network.

Specifically, the correspondence table T1 shown in FIG. 3 indicates the roles of the in-vehicle ECU 101 in a Local Interconnect Network (LIN), which is a communication standard for in-vehicle networks. The correspondence table T1 shows that the in-vehicle ECU 101 operates as a LIN commander in the case of a vehicle model X1, and the in-vehicle ECU 101 operates as a LIN responder in the case of vehicle models X2 and X3.

A correspondence table T2 shown in FIG. 4 shows the roles of the in-vehicle ECU 101 in WiFi, which is a communication standard for in-vehicle networks. The correspondence table T2 shows that the in-vehicle ECU 101 operates as an access point in the case of a vehicle model X11, and the in-vehicle ECU 101 operates as a station in the case of vehicle models X12 and X13. Hereinafter, each of the correspondence tables T1 and T2 may be referred to as a correspondence table T.

Returning to FIGS. 1 and 2, assume the case where the user performs an operation on the terminal device 161 to acquire provision information. In this case, the terminal device 161 transmits request information indicating a request for provision information to the management device 201 via the network 151.

In the management device 201, the communication unit 21 receives the request information transmitted by the terminal device 161 via the network 151, and outputs the received request information to the setting information creation unit 23.

The setting information creation unit 23 creates setting information based on the correspondence tables T. More specifically, the setting information creation unit 23 creates setting information for each vehicle model with reference to the correspondence table T1. The setting information creation unit 23 creates setting information indicating a LIN commander as setting information to be transmitted to vehicles 1 of the vehicle model X1. The setting information creation unit 23 creates setting information indicating a LIN responder as setting information to be transmitted to vehicles 1 of the vehicle models X2 and X3.

The setting information creation unit 23 then outputs the created setting information corresponding to the vehicle models X1 to X3 to the communication unit 21. The communication unit 21 transmits the setting information created by the setting information creation unit 23 via the network 151 to one or more vehicles 1 of the vehicle model X1, one or more vehicles 1 of the vehicle model X2, and one or more vehicles of the vehicle model X3.

In addition, the setting information creation unit 23 creates setting information for each vehicle model with reference to the correspondence table T2. The setting information creation unit 23 creates setting information indicating a WiFi access point as setting information to be transmitted to vehicles 1 of the vehicle model X11. The setting information creation unit 23 creates setting information indicating a WiFi station as setting information to be transmitted to vehicles 1 of the vehicle models X12 and X13.

The setting information creation unit 23 then outputs the created setting information corresponding to the vehicle models X11 to X13 to the communication unit 21. The communication unit 21 transmits the setting information created by the setting information creation unit 23 via the network 151 to one or more vehicles 1 of the vehicle model X11, one or more vehicles 1 of the vehicle model X12, and one or more vehicles of the vehicle model X13.

Note that the present disclosure is not limited to a configuration in which both the correspondence tables T1 and T2 are used, and a configuration in which the storage unit 22 stores either the correspondence table T1 or the correspondence table T2 may be used.

In addition, at least one of the correspondence tables T1 and T2 may indicate information regarding only one vehicle model. In other words, the setting information creation unit 23 may be configured to create setting information for only one vehicle model for a certain communication standard.

In addition, the storage unit 22 may be configured not to store the correspondence tables T. For example, the management device 201 may be configured so that the business operator can set detailed network settings. With this configuration, when the in-vehicle ECU 101 can be installed in a plurality of locations in one vehicle and the role of the in-vehicle ECU 101 may differ even between vehicles of the same model or year, it is possible to set a role appropriate to the location where the in-vehicle ECUs 101 is to be installed.

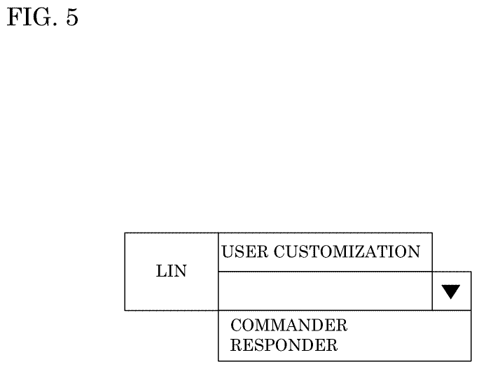

FIG. 5 is a diagram illustrating an example of a screen displayed by the management device according to the embodiment of the present disclosure. As shown in FIG. 5, the setting information creation unit 23 may be configured to perform processing for displaying, on a display device (not shown), a screen on which the role of the in-vehicle ECU 101 in the in-vehicle network can be input.

In the example shown in FIG. 5, a pull-down menu is displayed, and the business operator can select the role of the in-vehicle ECU 101 in LIN, which is a communication standard for in-vehicle networks, for each vehicle model, for example.

The setting information creation unit 23 creates setting information for each vehicle model, for example, based on the user's selection on the screen, and transmits the setting information to one or more vehicles 1 via the communication unit 21 and the network 151.

In the vehicle 1, the in-vehicle ECU 101 receives the setting information transmitted by the management device 201, and performs operation setting for the in-vehicle ECU 101 corresponding to the role indicated by the setting information based on the received setting information. For example, the in-vehicle ECU 101 performs operation setting so that vehicle information for creating provision information is transmitted to the management device 201. The operation setting performed by the in-vehicle ECU 101 will be described in detail later.

Returning to FIG. 2, in the management device 201, when the communication unit 21 receives the vehicle information transmitted by the in-vehicle ECU 101 via the network 151 after the operation setting is performed, the communication unit 21 outputs the received vehicle information to the provision information creation unit 24. The provision information creation unit 24 creates provision information based on the vehicle information received from the communication unit 21. The provision information creation unit 24 then stores the created provision information in the storage unit 22.

The communication unit 21 acquires the provision information stored in the storage unit 22 at a predetermined timing, for example, and transmits the acquired provision information to the terminal device 161 via the network 151. Accordingly, the user can execute a specific function using the provision information created by the management device 201.

Note that the setting information is not limited to information used to perform setting for transmitting vehicle information from the vehicle 1 to the management device 201 in order to create provision information, etc., and may be information used to perform some sort of other setting, such as setting for exchanging vehicle information confined within the vehicle 1.

In addition, the setting information is not limited to information indicating the role of the in-vehicle ECU 101 in communication in the in-vehicle network, and may also indicate other roles, such as whether or not to control an in-vehicle component 111 such as a sensor.

The setting information may further indicate the data type of the vehicle information to be transmitted to the management device 201, in addition to the role of the in-vehicle ECU 101.

In addition, a device other than the management device 201 may be configured to create provision information. In this case, the management device 201 transmits the vehicle information received from the vehicle 1 to the other device.

The user may also directly input a request for provision information or the like to the management device 201 without using the terminal device 161. In this case, the communication system 301 does not need to include the terminal device 161.

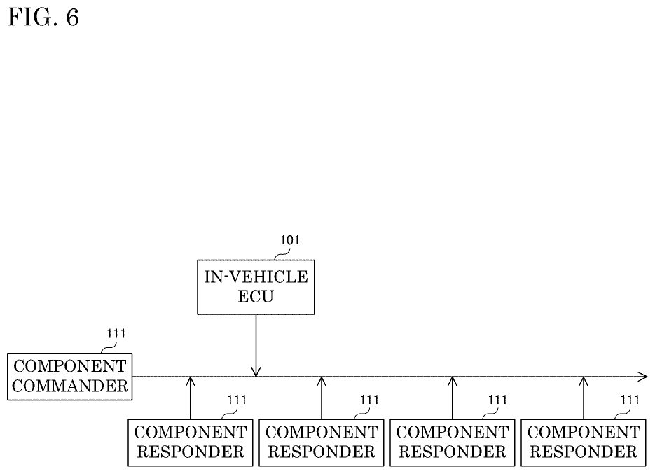

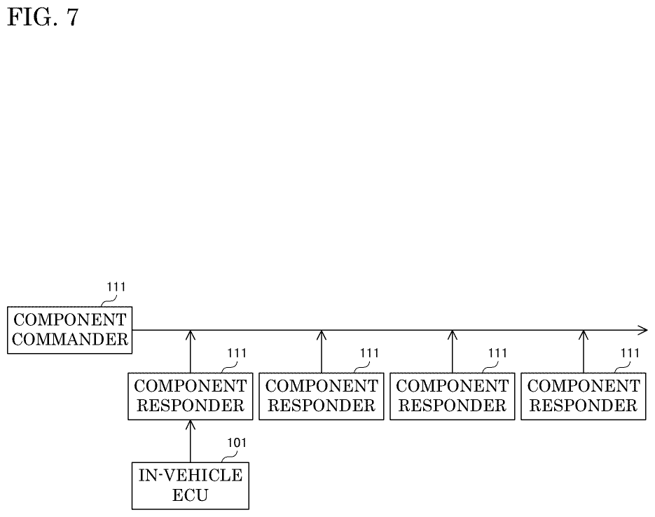

FIGS. 6 and 7 are diagrams illustrating the relationship between the connection position and the role of the in-vehicle device according to the embodiment of the present disclosure in the in-vehicle network.

FIG. 6 shows a case where the in-vehicle ECU 101 is newly connected to an existing network in the vehicle 1. In the existing network, an in-vehicle component 111 that operates as a commander (hereinafter also referred to as a component commander) and in-vehicle components 111 that operate as responders (hereinafter also referred to as component responders) are present. In response to a message request from the component commander, each component responder transmits a message to the network, i.e., to the component commander.

In this case, the in-vehicle ECU 101 is set as a responder. Based on the setting information received from the management device 201, the in-vehicle ECU 101 operates as a responder, receives a message transmitted over the network, acquires necessary vehicle information from the message, and transmits the vehicle information to the management device 201.

FIG. 7 shows a case where the in-vehicle ECU 101 cannot connect to the existing network in the vehicle 1 for some reason. If the in-vehicle component 111 corresponding to the vehicle information to be acquired has been specified, the user establishes a one-to-one connection between the component responder as the in-vehicle component 111 and the in-vehicle ECU 101. In this case, no component commander is present in the network between the in-vehicle component 111 and the in-vehicle ECU 101, and therefore the in-vehicle ECU 101 cannot receive a message from the in-vehicle component 111.

In this case, the in-vehicle ECU 101 is set as a commander. The in-vehicle ECU 101, as a commander, needs to transmit a message request to the in-vehicle component 111, which is a component responder, and acquire vehicle information.

### Configuration of in-Vehicle Device

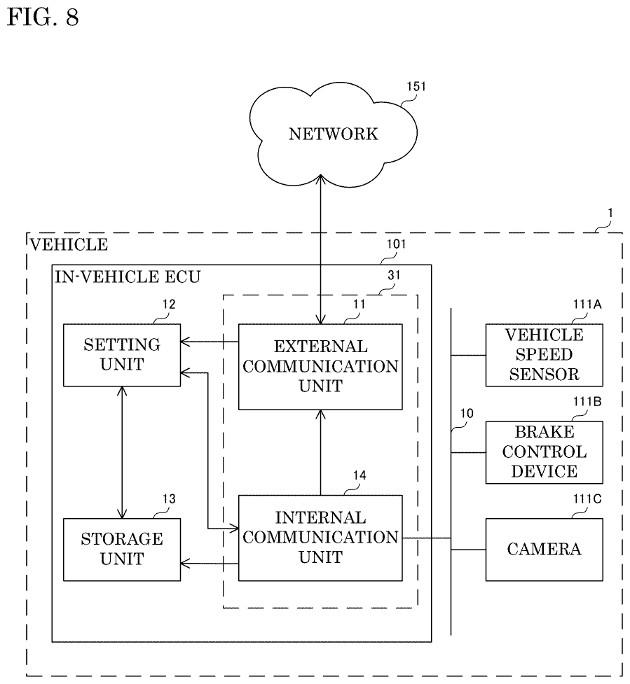

FIG. 8 is a diagram illustrating the configuration of the in-vehicle device according to the embodiment of the present disclosure and an example of a connection position of the in-vehicle device in the in-vehicle network. FIG. 8 shows a case where the in-vehicle ECU 101 is installed in the location shown in FIG. 6.

As shown in FIG. 8, when the in-vehicle ECU 101 is connected to a plurality of in-vehicle components 111 via, for example, a LIN bus 10, the in-vehicle ECU 101 can perform communication with the plurality of in-vehicle components 111. The in-vehicle ECU 101 includes a setting unit 12, a storage unit 13, and a communication unit 31. The communication unit 31 includes an external communication unit 11 and an internal communication unit 14. Some or all of the external communication unit 11, the setting unit 12, and the internal communication unit 14 are realized by a processor such as a CPU or a DSP. The storage unit 13 is, for example, a non-volatile memory.

The external communication unit 11 communicates with the management device 201 via the network 151 by performing wireless communication with a wireless base station (not shown) in accordance with a communication method such as WiFi, Long Term Evolution (LTE), or 5G. For example, the external communication unit 11 receives setting information transmitted by the management device 201 via the network 151 and outputs the received setting information to the setting unit 12. Note that the external communication unit 11 is not limited to being configured to perform communication with the management device 201 via a wireless base station and the network 151, and may be configured to perform communication with the management device 201 via a wired line.

Furthermore, the external communication unit 11 may be configured to perform communication with the management device 201 via another in-vehicle ECU 101.

The internal communication unit 14 performs communication with the plurality of in-vehicle components 111 in accordance with the LIN standard. For example, the internal communication unit 14 receives vehicle speed information transmitted by a vehicle speed sensor 111A, brake information transmitted by a brake control device 111B, and image information transmitted by a camera 111C. The vehicle speed information indicates the measurement result of the vehicle speed of the vehicle 1. The brake information indicates the brake state of the vehicle 1. The image information indicates a captured image of the surroundings of the vehicle 1.

Note that the in-vehicle ECU 101 and the in-vehicle components 111 are not limited to being configured to perform communication in accordance with LIN, and may be configured to perform communication in accordance with a standard such as Controller Area Network (CAN) (registered trademark), Clock Extension Peripheral Interface (CXPI), Ethernet (registered trademark), or Universal Serial Bus (USB). Also, the in-vehicle ECU 101 and the in-vehicle components 111 may be configured to perform wireless communication in accordance with a standard such as Bluetooth.

The setting unit 12 receives the setting information output by the external communication unit 11 and stores the setting information in the storage unit 13.

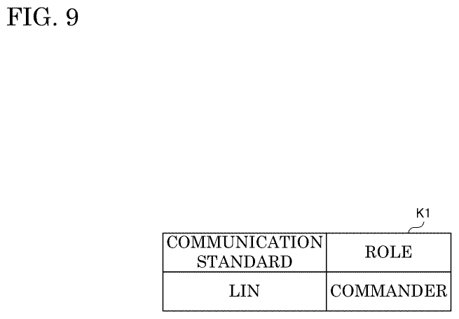

FIG. 9 is a diagram illustrating an example of setting information stored in the storage unit in the in-vehicle device according to the embodiment of the present disclosure.

As shown in FIG. 9, the setting unit 12 stores, as setting information, in the storage unit 13, a correspondence table K1 indicating a correspondence relationship between communication standards for the in-vehicle network and roles of the in-vehicle ECU 101 in the communication standard.

Returning to FIG. 8, the setting unit 12 performs operation setting for the in-vehicle ECU 101 corresponding to the role based on the setting information received by the external communication unit 11.

More specifically, the setting unit 12 performs operation setting for the in-vehicle ECU 101 based on the correspondence table K1 in the storage unit 13 at a predetermined timing, such as the timing at which the ignition switch of the vehicle 1 is switched on. The predetermined timing may be a timing corresponding to another event, such as a timing when the setting information is received, or may be a periodic timing.

For example, based on the setting information, the setting unit 12 sets the communication operation of the in-vehicle ECU 101 corresponding to the role in communication in the in-vehicle network. For example, the setting unit 12 uses the setting information to perform setting so that vehicle information regarding the vehicle 1 is transmitted from the vehicle 1 to the management device 201. Specifically, the setting unit 12 performs setting so that a predetermined type of vehicle information required for creating provision information is transmitted to the management device 201.

Specifically, for example, the setting unit 12 switches whether the in-vehicle ECU 101 is to perform communication as a commander or as a responder in the in-vehicle network based on the setting information. In addition, for example, the setting unit 12 switches whether the in-vehicle ECU 101 is to perform communication as an access point or as a station in the in-vehicle network based on the setting information.

For example, in a vehicle 1 of the vehicle model X1, the setting unit 12 performs setting on the in-vehicle ECU 101 so that vehicle speed information is transmitted to the management device 201.

More specifically, when the in-vehicle ECU 101 is connected to the LIN bus 10 as shown in FIG. 8 and vehicle speed information is transmitted from the vehicle speed sensor 111A to the LIN bus 10 periodically or irregularly, the setting unit 12 performs setting in the internal communication unit 14 so as to operate as a LIN responder to receive the vehicle speed information and output the received vehicle speed information to the external communication unit 11. Also, the setting unit 12 performs setting in the external communication unit 11 so as to transmit the vehicle speed information received from the internal communication unit 14 to the management device 201.

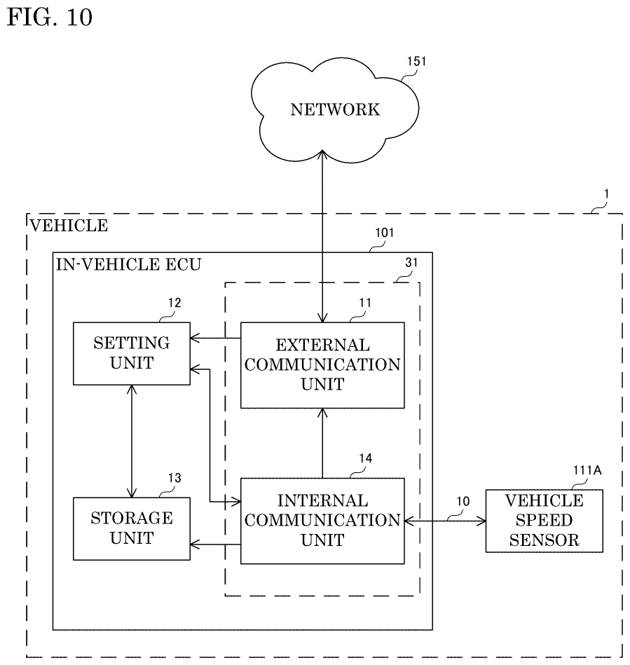

FIG. 10 is a diagram illustrating another example of a connection position of the in-vehicle device according to the embodiment of the present disclosure in the in-vehicle network. FIG. 10 shows a case where the in-vehicle ECU 101 is installed in the location shown in FIG. 7.

As shown in FIG. 10, when the in-vehicle ECU 101 is connected one-to-one to the vehicle speed sensor 111A and vehicle speed information is not transmitted from the vehicle speed sensor 111A to the internal communication unit 14, the setting unit 12 operates as a LIN commander and performs setting in the internal communication unit 14 so as to request the vehicle speed sensor 111A to transmit the vehicle speed information.

Upon receiving the request from the in-vehicle ECU 101, the vehicle speed sensor 111A periodically or irregularly transmits vehicle speed information to the in-vehicle ECU 101. Also, the setting unit 12 performs setting in the internal communication unit 14 so as to output the received vehicle speed information to the external communication unit 11. Also, the setting unit 12 performs setting in the external communication unit 11 so as to transmit the vehicle speed information received from the internal communication unit 14 to the management device 201.

By carrying out such setting processing, vehicle speed information necessary for creating provision information is transmitted to the management device 201.

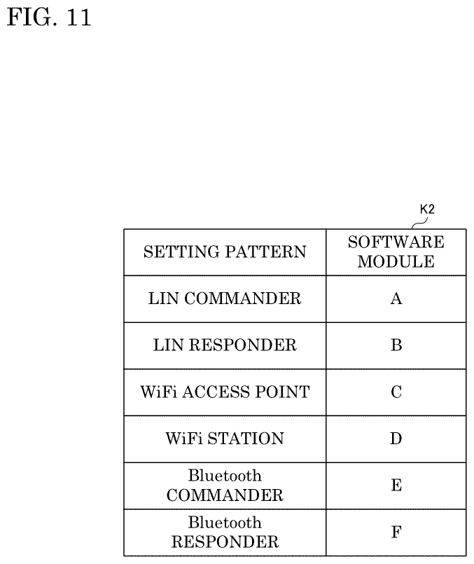

FIG. 11 is a diagram illustrating an example of a software module information stored in the storage unit of the in-vehicle device according to the embodiment of the present disclosure.

As shown in FIG. 11, the storage unit 13 stores, as software module information, a correspondence table K2 indicating the correspondence between setting information patterns and software modules.

Specifically, the software module corresponding to a LIN commander is A, the software module corresponding to a LIN responder is B, the software module corresponding to a WiFi access point is C, the software module corresponding to a WiFi station is D, the software module corresponding to a Bluetooth commander is E, and the software module corresponding to a Bluetooth responder is F.

The in-vehicle ECU 101 is equipped with the software modules A to F, and the setting unit 12 performs operation setting for the internal communication unit 14 by selectively enabling any one of the modules. Note that the in-vehicle ECU 101 may be equipped with software modules corresponding to one or more of the communication standards shown in FIG. 11.

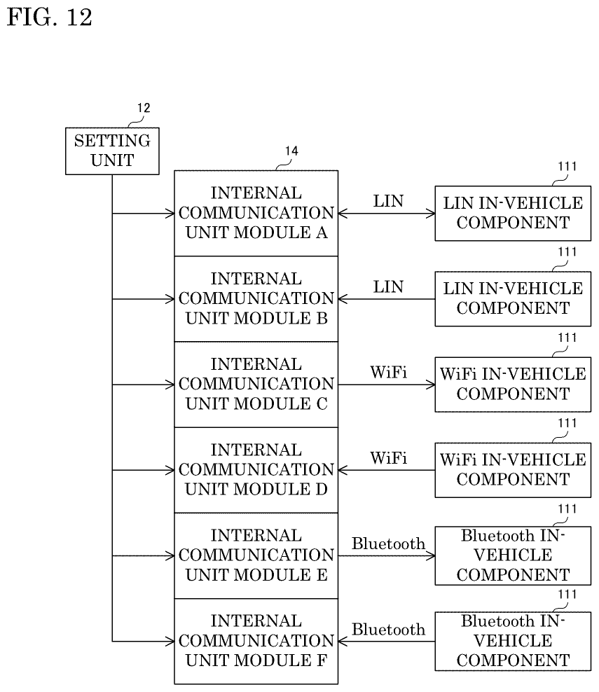

FIG. 12 is a diagram illustrating an example of a communication form for each of the software modules in the in-vehicle device according to the embodiment of the present disclosure.

As shown in FIG. 12, when setting the internal communication unit 14 to operate as a LIN commander, the setting unit 12 enables the software module A with reference to the correspondence table K2. In this case, for example, the internal communication unit 14 performs bidirectional communication with the LIN in-vehicle component 111.

When setting the internal communication unit 14 to operate as a LIN responder, the setting unit 12 enables the software module B with reference to the correspondence table K2. In this case, for example, the internal communication unit 14 receives information from the LIN in-vehicle component 111.

When setting the internal communication unit 14 to operate as a WiFi access point, the setting unit 12 enables the software module C with reference to the correspondence table K2. In this case, for example, the internal communication unit 14 transmits information to the WiFi in-vehicle component 111.

When setting the internal communication unit 14 to operate as a WiFi station, the setting unit 12 enables the software module D with reference to the correspondence table K2. In this case, for example, the internal communication unit 14 receives information from the WiFi in-vehicle component 111.

When setting the internal communication unit 14 to operate as a Bluetooth commander, the setting unit 12 enables the software module E with reference to the correspondence table K2. In this case, for example, the internal communication unit 14 transmits information to the Bluetooth in-vehicle component 111.

When setting the internal communication unit 14 to operate as a Bluetooth responder, the setting unit 12 enables the software module F with reference to the correspondence table K2. In this case, for example, the internal communication unit 14 receives information from the Bluetooth in-vehicle component 111.

With such a configuration, the in-vehicle ECU 101 can easily switch its role in communication in the in-vehicle network.

Note that the setting unit 12 may be configured so that, when storing the setting information received from the external communication unit 11 in the storage unit 13, or when performing operation setting for the in-vehicle ECU 101 with reference to the correspondence table K1 in the storage unit 13, the setting unit 12 determines the validity of the content of the setting information, for example, based on information stored in advance. Specifically, for example, when the setting information indicates any of the patterns registered in the correspondence table K2, the setting unit 12 determines that the content of the setting information is valid, and performs operation setting for the in-vehicle ECU 101 in accordance with the setting information. On the other hand, when the setting information indicates a pattern that is not registered in the correspondence table K2, the setting unit 12 determines that the content of the setting information is invalid, and maintains the current operation settings. In addition, the setting unit 12 may be configured to determine whether or not the content of the setting information is valid based on information indicating the actual configuration of the in-vehicle network in the vehicle 1, which is stored in advance, instead of using the correspondence table K2.

Note that the above-described “for each vehicle model” may be replaced with “for each vehicle year” or “for each combination of vehicle model and vehicle year”. In other words, the setting unit 12 creates setting information for at least one of each vehicle model and each vehicle year. Here, “vehicle year” means the year the vehicle was manufactured.

### Operation Flow

Next, the operation of devices in the communication system according to the embodiment of the present disclosure will be described with reference to the drawings.

The devices in the communication system 301 each have a computer that includes a memory, and in each of such devices, an arithmetic processing unit such as a CPU in the computer reads out, from the memory, a program that includes part or all of the steps of the sequence described below, and executes the program. The programs executed by the devices can be installed from an external source. The programs executed by the devices are distributed in a state of being stored in recording media.

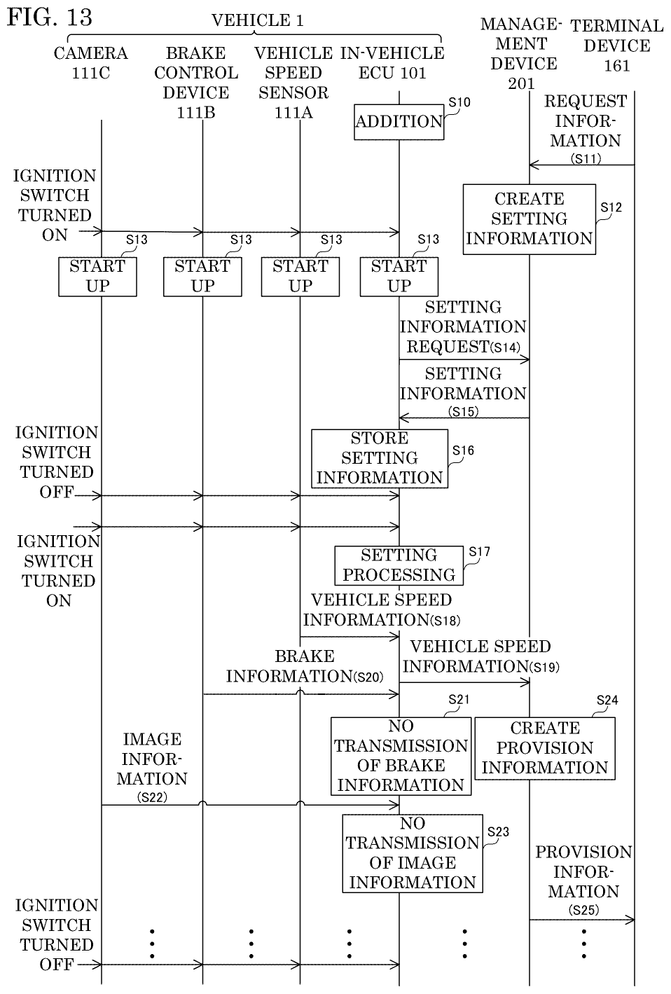

FIG. 13 is a diagram illustrating an example of a sequence in the communication system according to the embodiment of the present disclosure. The following describes the operation of devices including the in-vehicle ECU 101 and the plurality of in-vehicle components 111 in the vehicle 1 of the vehicle model X2, as well as the management device 201, and the terminal device 161. Here, assume that the in-vehicle components 111 are the vehicle speed sensor 111A, the brake control device 111B, and the camera 111C.

As shown in FIG. 13, first, assume that the user has installed the in-vehicle ECU 101 in the vehicle 1 at the position shown in FIG. 8 (step S10).

Next, assume that the user operates the terminal device 161 to acquire provision information. In this case, the terminal device 161 transmits request information indicating a request for provision information to the management device 201 via the network 151 (step S11).

Next, upon receiving request information transmitted by the terminal device 161, the management device 201 creates setting information for each vehicle model. Specifically, for example, the management device 201 creates setting information indicating a LIN responder as setting information corresponding to the vehicle model X2 (step S12).

Next, for example, when the ignition switch of the vehicle 1 is switched on, the in-vehicle ECU 101, the vehicle speed sensor 111A, the brake control device 111B, and the camera 111C in the vehicle 1 start up (step S13).

Next, the in-vehicle ECU 101 transmits a setting information request, which is for checking whether setting information has been created, to the management device 201 via the network 151 (step S14).

The setting information request includes, for example, identification information of the in-vehicle ECU 101 that is the transmission source, and the vehicle model X2 of the vehicle 1 in which the in-vehicle ECU 101 is installed. Note that the in-vehicle ECU 101 is not limited to being configured to transmit the setting information request upon being started up, and may be configured to transmit the setting information request periodically or irregularly until the ignition switch of the vehicle 1 is switched from the on state to the off state.

Next, upon receiving the setting information request transmitted by the in-vehicle ECU 101, the management device 201 determines that “X2” is the vehicle model of the vehicle 1 that includes the in-vehicle ECU 101 that is the transmission source of the received setting information request. Furthermore, the management device 201 checks whether or not setting information corresponding to the vehicle model X2 has been created. Here, since the management device 201 has created setting information corresponding to the vehicle model X2, the management device 201 transmits the setting information via the network 151 to the in-vehicle ECU 101 that is the transmission source of the setting information request (step S15).

Next, upon receiving the setting information transmitted by the management device 201, the in-vehicle ECU 101 stores the received setting information in the storage unit 13 (step S16).

Next, when the ignition switch of the vehicle 1 is switched to the off state and then switched to the on state, the setting unit 12 performs operation setting for the in-vehicle ECU 101 based on the setting information in the storage unit 13. Specifically, the in-vehicle ECU 101 performs setting so that the internal communication unit 14 operates as a LIN responder to receive vehicle speed information and the received vehicle speed information is transmitted to the management device 201, as described above. Thereafter, vehicle speed information from the vehicle speed sensor 111A is transmitted to the management device 201 (step S17).

Next, the in-vehicle ECU 101 receives the vehicle speed information transmitted by the vehicle speed sensor 111A (step S18).

Next, the in-vehicle ECU 101 transmits the received vehicle speed information to the management device 201 via the network 151 in accordance with the content of the above-described setting processing (step S19).

Next, the in-vehicle ECU 101 receives the brake information transmitted by the brake control device 111B (step S20).

Next, the in-vehicle ECU 101 does not transmit the received brake information to the management device 201 in accordance with the content of the above-described setting processing (step S21).

Next, the in-vehicle ECU 101 receives the image information transmitted by the camera 111C (step S22).

Next, the in-vehicle ECU 101 does not transmit the received image information to the management device 201 in accordance with the content of the above-described setting processing (step S23).

Next, upon receiving the vehicle speed information transmitted by the in-vehicle ECU 101 via the network 151, the management device 201 uses the received vehicle speed information to create provision information (step S24).

Next, for example, the management device 201 transmits the created provision information to the terminal device 161 via the network 151 (step S25). Accordingly, the user can execute a specific function using the provision information created by the management device 201. Then, until the ignition switch of the vehicle 1 is switched off, operations similar to those of steps S18 to S25 described above are repeatedly performed. When the ignition switch of the vehicle 1 is switched off, the in-vehicle ECU 101, the vehicle speed sensor 111A, the brake control device 111B, and the camera 111C are stopped.

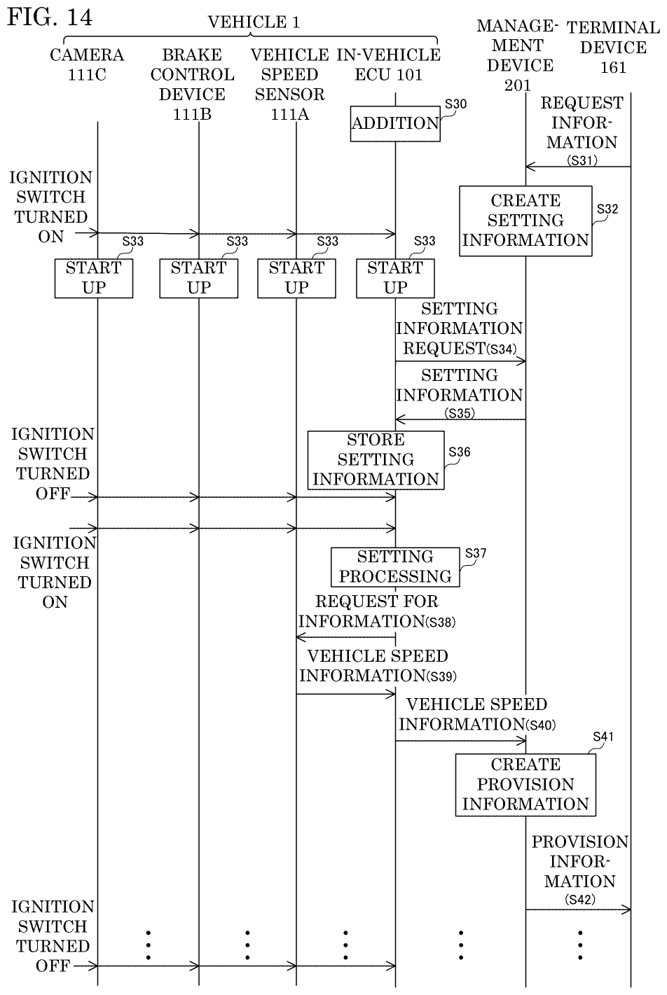

FIG. 14 is a diagram illustrating another example of the sequence in the communication system according to the embodiment of the present disclosure.

As shown in FIG. 14, first, assume that the user has installed the in-vehicle ECU 101 in the vehicle 1 at the position shown in FIG. 10 (step S30).

The processing in steps S31 to S36 is similar to the processing in steps S11 to S16 shown in FIG. 13.

Next, when the ignition switch of the vehicle 1 is switched to the off state and then switched to the on state, the setting unit 12 performs operation setting for the in-vehicle ECU 101 based on the setting information in the storage unit 13. Specifically, as described above, the in-vehicle ECU 101 performs setting so that the internal communication unit 14 operates as a LIN commander to request the vehicle speed sensor 111A to transmit vehicle speed information, and the received vehicle speed information is transmitted to the management device 201 (step S37).

Next, the in-vehicle ECU 101, as a LIN commander, requests the vehicle speed sensor 111A to transmit vehicle speed information. Thereafter, vehicle speed information is transmitted from the vehicle speed sensor 111A, and is transmitted to the management device 201 via the in-vehicle ECU 101 (step S38).

Next, the in-vehicle ECU 101 receives the vehicle speed information transmitted by the vehicle speed sensor 111A (step S39).

Next, the in-vehicle ECU 101 transmits the received vehicle speed information to the management device 201 via the network 151 (step S40).

Next, upon receiving the vehicle speed information transmitted by the in-vehicle ECU 101 via the network 151, the management device 201 uses the received vehicle speed information to create provision information (step S41).

Next, for example, the management device 201 transmits the created provision information to the terminal device 161 via the network 151 (step S42). Accordingly, the user can execute a specific function using the provision information created by the management device 201. Then, until the ignition switch of the vehicle 1 is switched off, operations similar to those of steps S39 to S42 described above are repeatedly performed. When the ignition switch of the vehicle 1 is switched off, the in-vehicle ECU 101, the vehicle speed sensor 111A, the brake control device 111B, and the camera 111C are stopped.

Note that the management device 201 is not limited to being configured to receive a user's request for provision information, and may be configured to allow the business operator who manages the management device 201 to specify the vehicle model or year on the management device 201, transmit setting information to the vehicle 1, and create provision information. The management device 201 may also be configured to automatically transmit setting information to the vehicle 1 and create provision information based on, for example, some sort of information.

Furthermore, the in-vehicle ECU 101, the vehicle speed sensor 111A, the brake control device 111B, and the camera 111C may be configured to be started up or stopped according to a trigger other than the ignition switch being switched to the on state or the off state.

Also, in the case where the management device 201 receives a setting information request from the in-vehicle ECU 101 (step S14 or S34) and has not created corresponding setting information, the management device 201 does not transmit setting information to the in-vehicle ECU 101.

In addition, regarding communication performed within the vehicle 1, for example, initial setting of the in-vehicle ECU 101 performed using a diagnostic tool or the like may be performed on the vehicle 1 at the dealer or the like. In this case, even if the in-vehicle ECU 101 has never received any setting information from the management device 201, communication between the in vehicle component 111 and the in vehicle ECU 101 can be performed normally.

In addition, some or all of the functions of the management device 201 according to the embodiment of the present disclosure may be provided by cloud computing. In other words, the management device 201 according to the embodiment of the present disclosure may be a cloud server configured by a plurality of servers.

The foregoing embodiments are to be construed in all respects as illustrative and not restrictive. The scope of the present disclosure is defined by the claims rather than the description above, and is intended to include all modifications within the meaning and scope of the claims and equivalents thereof.

1. An in-vehicle device to be installed in a vehicle, the in-vehicle device comprising:
a communication unit configured to receive, from a management device, setting information related to a role of the in-vehicle device in an in-vehicle network; and
a setting unit configured to perform operation setting for the in-vehicle device corresponding to the role based on the setting information received by the communication unit.

2. The in-vehicle device according to claim 1, wherein, based on the setting information, the setting unit sets a communication operation of the in-vehicle device corresponding to the role in communication in the in-vehicle network.

3. The in-vehicle device according to claim 2, wherein, based on the setting information, the setting unit switches whether the in-vehicle device is to perform communication as a commander or as a responder in the in-vehicle network.

4. The in-vehicle device according to claim 2, wherein, based on the setting information, the setting unit switches whether the in-vehicle device is to perform communication as an access point or as a station in the in-vehicle network.

5. The in-vehicle device according to claim 2,
wherein the setting information indicates a communication standard for the in-vehicle network and the role in the communication standard,
the in-vehicle device is equipped with a plurality of software modules, and
when setting the communication operation, the setting unit selects, from among the plurality of software modules, a software module corresponding to the communication standard and the role in the communication standard indicated by the setting information, and enables the selected software module.

6. The in-vehicle device according to claim 5, wherein the setting unit uses correspondence information indicating a correspondence between the setting information and the software modules to select, from among the plurality of software modules, the software module corresponding to the communication standard and the role in the communication standard indicated by the setting information.

7. The in-vehicle device according to claim 1, wherein the communication unit receives the setting information for at least one of each vehicle model and each vehicle year.

8. The in-vehicle device according to claim 1, wherein the setting information indicates the role of the in-vehicle device and a data type of vehicle information related to the vehicle to be transmitted to the management device.

9. The in-vehicle device according to claim 1,
wherein the communication unit receives the setting information for at least one of each vehicle model and each vehicle year, and
the setting information indicates the role of the in-vehicle device and a data type of vehicle information related to the vehicle to be transmitted to the management device.

10. The in-vehicle device according to claim 1, wherein the setting unit uses the setting information in setting performed so that vehicle information regarding the vehicle is transmitted from the vehicle to the management device.

11. An information processing method in an in-vehicle device to be installed in a vehicle, comprising the steps of:
receiving, from a management device, setting information related to a role of the in-vehicle device in an in-vehicle network; and
performing operation setting for the in-vehicle device corresponding to the role based on the received setting information.

12. A computer program product for use in an in-vehicle device to be installed in a vehicle, the computer program product comprising a non-transitory, machine-readable medium storing instructions which, when executed by at least one programmable processor, causes at least one programmable processor to cause a computer to function as:
a communication unit configured to receive, from a management device, setting information related to a role of the in-vehicle device in an in-vehicle network; and
a setting unit configured to perform operation setting for the in-vehicle device corresponding to the role based on the setting information received by the communication unit.
